(19) United States
(12) Patent Application Publication
(10) Pub. No.: US 2026/0012256 A1
(43) Pub. Date: Jan. 8, 2026

(54) METHOD FOR FEEDING BACK CHANNEL QUALITY INFORMATION AND APPARATUS

(71) Applicant: HUAWEI TECHNOLOGIES CO., LTD., Shenzhen (CN)

(72) Inventors: Wei Wang, Shanghai (CN); Junping Zhang, Shenzhen (CN)

(73) Assignee: HUAWEI TECHNOLOGIES CO., LTD., Shenzhen (CN)

(21) Appl. No.: 19/328,910

(22) Filed: Sep. 15, 2025

Related U.S. Application Data
(63) Continuation of application No. PCT/CN2023/081946, filed on Mar. 16, 2023.

(51) Int. Cl. H04B 10/079

(52) U.S. Cl. CPC H04B 10/0795

(57) ABSTRACT

This application provides a method for feeding back channel quality information and an apparatus, to reduce feedback overheads of the channel quality information. The method includes: A terminal device sends first indication information and M pieces of first channel quality information that correspond to N sub-channels and that are measured in a first time unit to a network device; and the terminal device sends second indication information and L pieces of third channel quality information that correspond to the N sub-channels and that are measured in a second time unit to the network device, where third channel quality information of a first sub-channel in the N sub-channels indicates a difference between second channel quality information of the first sub-channel and first channel quality information of the first sub-channel.

### CROSS-REFERENCE TO RELATED APPLICATIONS

This application is a continuation of International Application No. PCT/CN2023/081946, filed on Mar. 16, 2023, the disclosure of which is hereby incorporated by reference in its entirety.

### TECHNICAL FIELD

This application relates to the communication field, and more specifically, to a method for feeding back channel quality information and an apparatus.

### BACKGROUND

Space optical communication is a wireless communication technology. A high-speed and high-bandwidth optical communication system has a bandwidth above GHz, and uses a multi-carrier modulation technology. In an indoor communication scenario with low-speed mobility and a line of sight, signals are subject to frequency selective fading and block fading. To implement high-rate data transmission, an optical communication channel having a specific bandwidth needs to be divided into a plurality of sub-channels, and channel quality information of each sub-channel needs to be measured. After obtaining the channel quality information of each sub-channel, a network device adjusts a plurality of transmission-related parameters such as bandwidth and power resource allocation, modulation, and retransmission, to obtain better signal transmission quality.

In the Institute of Electrical and Electronics Engineers (IEEE) standard, an optical communication channel is divided into eight sub-channels. A terminal device measures wavelength quality indicators (WQI) of the eight sub-channels, and feeds back the WQIs respectively corresponding to the eight sub-channels to the network device. Each fed-back WQI occupies 8 bits, and the WQI is normalized from 0x00 to 0xff. 0x00 is associated with a lowest WQI of the sub-channel, and 0xff is associated with a highest WQI of the sub-channel. The WQI and a channel quality indicator (CQI) may represent channel quality. However, in a scenario with high bandwidth and significant channel frequency selective fading, WQIs of different sub-channels vary greatly. If the WQI fed back by the terminal device to the network device is normalized from 0x00 to 0xff, it is difficult to ensure precision of the fed-back WQI. If the terminal device feeds back an actually measured WQI to the network device, overheads in a feedback process are high.

Currently, a channel quality feedback solution based on frequency domain differentiation is provided. In this solution, the terminal device averages CQIs obtained through measurement on all bands/sub-channels to obtain CQIₘₑₐₙ, and then obtains differences between CQIₘₑₐₙ and CQIs of different bands. The terminal device feeds back, to the network device, a difference between a CQI corresponding to each band and CQIₘₑₐₙ. However, in the scenario with high bandwidth and significant channel frequency selective fading, differences between CQIₘₑₐₙ and CQIs of some sub-channels are large. As a result, the differences between CQIₘₑₐₙ and the CQIs of the sub-channels occupy a large quantity of bits, and overheads in a feedback process are also high.

### SUMMARY

This application provides a method for feeding back channel quality information and an apparatus, to reduce feedback overheads of the channel quality information while precision of the fed-back channel quality information is ensured.

According to a first aspect, a method for feeding back channel quality information is provided. The method may be performed by a terminal device or a chip or a chip system on a terminal device side. The method includes: The terminal device sends a first data packet to a network device, where the first data packet includes first indication information and M pieces of first channel quality information corresponding to N sub-channels, the first indication information indicates that the channel quality information in the first data packet is originally measured channel quality information, the first channel quality information is measured by the terminal device in a first time unit, the N sub-channels are communication channels between the terminal device and the network device, N is an integer greater than 1, and M is a positive integer less than or equal to N; and the terminal device sends a second data packet to the network device, where the second data packet includes second indication information and L pieces of third channel quality information corresponding to the N sub-channels, third channel quality information of a first sub-channel corresponding to the N sub-channels indicates a difference between second channel quality information corresponding to the first sub-channel and first channel quality information corresponding to the first sub-channel, the second channel quality information is measured by the terminal device in a second time unit, the second indication information indicates that the channel quality information in the second data packet is non-originally measured channel quality information, L is a positive integer less than or equal to N, and the second time unit is later than the first time unit.

Based on the foregoing technical solution, because the third channel quality information of the first sub-channel in the N sub-channels indicates the difference between the second channel quality information corresponding to the first sub-channel and the first channel quality information corresponding to the first sub-channel, a quantity of bits occupied by the L pieces of third channel quality information corresponding to the N sub-channels is less than a quantity of bits occupied by second channel quality information corresponding to the N sub-channels. Therefore, in comparison with directly feeding back the second channel quality information corresponding to the N sub-channels, in this embodiment of this application, the terminal device feeds back the L pieces of third channel quality information to the network device, so that feedback overheads of the channel quality information can be reduced. In comparison with a solution in which a fed-back WQI is normalized from 0x00 to 0xff, in this embodiment of this application, normalization processing is not performed on the fed-back channel quality information, so that precision of the fed-back channel quality information can be ensured. It can be learned from the foregoing that, according to the technical solutions provided in this embodiment of this application, the feedback overheads of the channel quality information can be reduced while precision of the fed-back channel quality information is ensured.

With reference to the first aspect, in some implementations of the first aspect, the first data packet further includes third indication information, and the third indication information indicates a quantity of bits of an integer part and a quantity of bits of a fractional part corresponding to the M pieces of first channel quality information. The second data packet further includes fourth indication information, and the fourth indication information indicates a quantity of bits of an integer part and a quantity of bits of a fractional part corresponding to the L pieces of third channel quality information.

With reference to the first aspect, in some implementations of the first aspect, the third indication information further indicates a quantity of bits of a sign part corresponding to the M pieces of first channel quality information; and the fourth indication information further indicates a quantity of bits of a sign part corresponding to the L pieces of third channel quality information.

The M pieces of first channel quality information in the first data packet are encoded by the terminal device and then sent to the network device, and the third indication information is used by the network device to decode the M pieces of first channel quality information in the first data packet, to obtain the decoded first channel quality information respectively corresponding to the N sub-channels. The L pieces of third channel quality information in the second data packet are encoded by the terminal device and then sent to the network device, and the fourth indication information is used by the network device to decode the L pieces of third channel quality information in the second data packet, to obtain the decoded third channel quality information respectively corresponding to the N sub-channels.

With reference to the first aspect, in some implementations of the first aspect, the third channel quality information corresponding to the first sub-channel is equal to the difference between the second channel quality information corresponding to the first sub-channel and the first channel quality information corresponding to the first sub-channel.

With reference to the first aspect, in some implementations of the first aspect, the M pieces of first channel quality information are in one-to-one correspondence with the N sub-channels, and M is equal to N; or each of the M pieces of first channel quality information corresponds to at least one second sub-channel in the N sub-channels, different second sub-channels in the at least one second sub-channel have same first channel quality information, and M is less than N.

Based on the foregoing solution, when a plurality of second sub-channels in the N sub-channels respectively correspond to same or similar first channel quality information, the terminal device needs to feed back only one piece of first channel quality information for the plurality of second sub-channels. Therefore, an amount of first channel quality information that the terminal device needs to feed back to the network device is reduced, to reduce feedback overheads of the channel quality information.

With reference to the first aspect, in some implementations of the first aspect, the L pieces of third channel quality information are in one-to-one correspondence with the N sub-channels, and L is equal to N; or each of the L pieces of third channel quality information corresponds to at least one third sub-channel in the N sub-channels, different third sub-channels in the at least one third sub-channel have same third channel quality information, and L is less than N.

Based on the foregoing solution, when a plurality of third sub-channels in the N sub-channels respectively correspond to same or similar third channel quality information, the terminal device needs to feed back only one piece of third channel quality information for the plurality of third sub-channels. Therefore, an amount of third channel quality information that the terminal device needs to feed back to the network device is reduced, to reduce feedback overheads of the channel quality information.

With reference to the first aspect, in some implementations of the first aspect, the first data packet further includes fifth indication information, and the fifth indication information indicates a sequence number of the first data packet. The second data packet further includes sixth indication information, and the sixth indication information indicates a sequence number of the second data packet. Data packets sent by the terminal device to the network device are numbered by using sequence numbers, and sequence numbers of two adjacent data packets sent by the terminal device are consecutive. If a sequence number of a data packet received by the network device this time and a sequence number of a data packet received last time are inconsecutive, it indicates that a packet loss occurs, and the network device may determine that a bit error occurs in the channel quality information sent by the terminal device.

With reference to the first aspect, in some implementations of the first aspect, the method further includes: The terminal device receives first instruction information from the network device, where the first instruction information indicates the terminal device to send a data packet corresponding to the originally measured channel quality information.

Based on the foregoing solution, when the network device determines that a bit error occurs in the third channel quality information in the second data packet, the network device may send the first instruction information to the terminal device, where the first instruction information indicates the terminal device to send the data packet corresponding to the originally measured channel quality information, so that accuracy of the channel quality information obtained by the network device can be improved.

With reference to the first aspect, in some implementations of the first aspect, that the terminal device sends the second data packet to the network device includes: If a total quantity of bits corresponding to the L pieces of third channel quality information is less than a total quantity of bits of second channel quality information corresponding to the N sub-channels, the terminal device sends the second data packet to the network device.

With reference to the first aspect, in some implementations of the first aspect, the method further includes: If the total quantity of bits corresponding to the L pieces of third channel quality information is greater than or equal to the total quantity of bits of the second channel quality information corresponding to the N sub-channels, the terminal device sends a third data packet to the network device, where the third data packet includes seventh indication information and the second channel quality information corresponding to the N sub-channels, and the seventh indication information indicates that the channel quality information in the third data packet is originally measured channel quality information.

Based on the foregoing solution, a smaller total quantity of bits corresponding to all channel quality information in a data packet sent by the terminal device to the network device indicates lower required transmission overheads, so that transmission resources can be saved.

With reference to the first aspect, in some implementations of the first aspect, the method further includes at least one of the following: The terminal device measures, in the first time unit, the first channel quality information respectively corresponding to the N sub-channels; or the terminal device measures, in the second time unit, the second channel quality information respectively corresponding to the N sub-channels.

With reference to the first aspect, in some implementations of the first aspect, the first channel quality information includes a channel quality indicator CQI or a waveform quality indicator WQI; the second channel quality information includes a CQI or a WQI; and the third channel quality information includes a CQI or a WQI.

According to a second aspect, a method for feeding back channel quality information is provided. The method may be performed by a network device or a chip or a chip system on a network device side. The method includes: The network device receives a first data packet from a terminal device, where the first data packet includes first indication information and M pieces of first channel quality information corresponding to N sub-channels, the first indication information indicates that the channel quality information in the first data packet is originally measured channel quality information, the first channel quality information is measured by the terminal device in a first time unit, the N sub-channels are communication channels between the terminal device and the network device, N is an integer greater than 1, and M is a positive integer less than or equal to N; and the network device receives a second data packet from the terminal device, where the second data packet includes second indication information and L pieces of third channel quality information corresponding to the N sub-channels, third channel quality information corresponding to a first sub-channel in the N sub-channels indicates a difference between second channel quality information corresponding to the first sub-channel and first channel quality information corresponding to the first sub-channel, the second channel quality information is measured by the terminal device in a second time unit, the second indication information indicates that the channel quality information in the second data packet is non-originally measured channel quality information, L is a positive integer less than or equal to N, and the second time unit is later than the first time unit.

The method provided in the second aspect is a method on the network device side that corresponds to the first aspect. For beneficial effects thereof, directly refer to the first aspect.

With reference to the second aspect, in some implementations of the second aspect, the first data packet further includes third indication information, and the third indication information indicates a quantity of bits of an integer part and a quantity of bits of a fractional part corresponding to the M pieces of first channel quality information. The second data packet further includes fourth indication information, and the fourth indication information indicates a quantity of bits of an integer part and a quantity of bits of a fractional part corresponding to the L pieces of third channel quality information.

With reference to the second aspect, in some implementations of the second aspect, the third indication information further indicates a quantity of bits of a sign part corresponding to the M pieces of first channel quality information; and the fourth indication information further indicates a quantity of bits of a sign part corresponding to the L pieces of third channel quality information.

With reference to the second aspect, in some implementations of the second aspect, the third channel quality information corresponding to the first sub-channel is equal to the difference between the second channel quality information corresponding to the first sub-channel and the first channel quality information corresponding to the first sub-channel.

With reference to the second aspect, in some implementations of the second aspect, the M pieces of first channel quality information are in one-to-one correspondence with the N sub-channels, and M is equal to N; or each of the M pieces of first channel quality information corresponds to at least one second sub-channel in the N sub-channels, different second sub-channels in the at least one second sub-channel have same first channel quality information, and M is less than N.

With reference to the second aspect, in some implementations of the second aspect, the L pieces of third channel quality information are in one-to-one correspondence with the N sub-channels, and L is equal to N; or each of the L pieces of third channel quality information corresponds to at least one third sub-channel in the N sub-channels, different third sub-channels in the at least one third sub-channel have same third channel quality information, and L is less than N.

With reference to the second aspect, in some implementations of the second aspect, the first data packet further includes fifth indication information, and the fifth indication information indicates a sequence number of the first data packet. The second data packet further includes sixth indication information, and the sixth indication information indicates a sequence number of the second data packet.

With reference to the second aspect, in some implementations of the second aspect, the method further includes: The network device sends first instruction information to the terminal device, where the first instruction information indicates the terminal device to send a data packet corresponding to the originally measured channel quality information.

With reference to the second aspect, in some implementations of the second aspect, the method further includes: The network device receives a third data packet from the terminal device, where the third data packet includes seventh indication information and second channel quality information corresponding to the N sub-channels, and the seventh indication information indicates that the channel quality information in the third data packet is originally measured channel quality information.

According to a third aspect, a communication apparatus is provided. The apparatus may be used in the terminal device according to the first aspect. The apparatus includes: a transceiver unit, configured to implement a sending function and a receiving function of the method according to the first aspect; and a measurement unit, configured to implement measurement functions such as measuring the first channel quality information and the second channel quality information in the method according to the first aspect.

According to a fourth aspect, a communication apparatus is provided. The apparatus may be used in the network device according to the second aspect. The apparatus includes a transceiver unit, configured to implement a receiving function and a sending function in the method according to the second aspect.

According to a fifth aspect, a communication device is provided. The communication device includes a processor and a memory. The memory is configured to store a computer program, and the processor is configured to execute the computer program stored in the memory, to enable the communication device to perform the method according to any one of the first aspect and the possible implementations of the first aspect.

According to a sixth aspect, a communication device is provided. The communication device includes a processor and a memory. The memory is configured to store a computer program, and the processor is configured to execute the computer program stored in the memory, to enable the communication device to perform the method according to any one of the second aspect and the possible implementations of the second aspect.

According to a seventh aspect, a communication apparatus is provided. The communication apparatus includes an input/output interface and a logic circuit. The input/output interface is configured to obtain input information and/or output information; and the logic circuit is configured to perform the method according to any one of the first aspect and the possible implementations of the first aspect, and perform processing and/or generate the output information based on the input information.

According to an eighth aspect, a communication apparatus is provided. The communication apparatus includes an input/output interface and a logic circuit. The input/output interface is configured to obtain input information and/or output information; and the logic circuit is configured to perform the method according to any one of the second aspect and the possible implementations of the second aspect, and perform processing and/or generate the output information based on the input information.

According to a ninth aspect, a communication system is provided. The communication system includes a terminal device and a network device. The terminal device is configured to implement the method according to any one of the first aspect and the possible implementations of the first aspect, and the network device is configured to implement the method according to any one of the second aspect and the possible implementations of the second aspect.

According to a tenth aspect, a computer-readable storage medium is provided. The computer-readable medium stores a computer program. When the computer program is run on a computer, the computer is enabled to perform the method according to any one of the first aspect or the second aspect and the possible implementations of the first aspect or the second aspect.

According to an eleventh aspect, a computer program product including instructions is provided. When the instructions are executed by a computer, a communication apparatus is enabled to implement the method according to any one of the first aspect or the second aspect and the possible implementations of the first aspect or the second aspect.

The solutions provided in the third aspect to the eleventh aspect are for implementing or cooperating to implement the method provided in the first aspect or the second aspect, and therefore, can achieve beneficial effects the same as or corresponding to those in the first aspect or the second aspect. Details are not described herein again.

### BRIEF DESCRIPTION OF DRAWINGS

FIG. 1 is a diagram of a system architecture to which an embodiment of this application is applicable;

FIG. 2 is a diagram of indoor space optical communication with a line of sight;

FIG. 3 is a diagram of channel quality fed back based on frequency domain differentiation;

FIG. 4 is a diagram of relationships between signal-to-noise ratios (SNR) and channel frequencies in different time units in a quasi-static high-bandwidth communication scenario and a high-bandwidth communication scenario with low-speed mobility;

FIG. 5 is a schematic interaction flowchart of a method for feeding back channel quality information according to an embodiment of this application;

FIG. 6 is a diagram of sending, by a terminal device, channel quality information to a network device in different time units according to an embodiment of this application;

FIG. 7 is a diagram of relationships between frequencies and ΔSNR that are fed back by a terminal device to a network device in a second time unit to a sixth time unit according to an embodiment of this application;

FIG. 8 is a block diagram of a communication apparatus according to an embodiment of this application;

FIG. 9 is a block diagram of another communication apparatus according to an embodiment of this application; and

FIG. 10 is a block diagram of a communication device according to an embodiment of this application.

### DESCRIPTION OF EMBODIMENTS

The following describes the technical solutions of this application with reference to the accompanying drawings.

Embodiments of this application may be applied to various communication systems, for example, a wireless local area network (WLAN) system, a narrow band Internet of Things (NB-IoT) system, a global system for mobile communications (GSM), an enhanced data rate GSM evolution (EDGE) system, a wideband code division multiple access (WCDMA) system, a code division multiple access 2000 (CDMA2000) system, a time division-synchronization code division multiple access (TD-SCDMA) system, a long term evolution (LTE) system, satellite communication, a 5th generation (5G) communication system, and a 6th generation (6G) communication system, or a new communication system that will emerge in the future.

The communication system to which this application is applicable includes one or more transmit ends and one or more receive ends. Signal transmission between the transmit end and the receive end may be performed by using a radio wave, or may be performed by using a transmission medium such as visible light, a laser, infrared, and an optical fiber.

For example, the transmit end may be a terminal device, a base station, or another device that can obtain perception information and/or artificial intelligence information, or a chip or a chip system in these devices. The receive end may be a perception center that performs fusion processing on the perception information and/or the artificial intelligence information, or a chip or a chip system in the perception center.

The terminal device in embodiments of this application may include various handheld devices, vehicle-mounted devices, wearable devices, or computing devices that have a wireless communication function, or another processing device connected to a wireless modem. The terminal may be a mobile station (MS), a subscriber unit, user equipment (UE), a cellular phone, a smart phone, a wireless data card, a personal digital assistant (PDA) computer, a tablet computer, a wireless modem, a handheld device (handset), a laptop computer, an uncrewed aerial vehicle, a machine type communication (MTC) terminal, a wireless terminal in self-driving, or the like. The user equipment includes vehicle user equipment.

For example, the network device may be an evolved NodeB (eNB), a radio network controller (RNC), a NodeB (NB), a base station controller (BSC), a base transceiver station (BTS), a home evolved NodeB (home NodeB, HNB), a baseband unit (BBU), a device that bears a base station function in device to device (D2D), an access point (AP) in a wireless fidelity (Wi-Fi) system, a wireless relay node, a wireless backhaul node, an uncrewed aerial vehicle, a transmission point (TP), a transmission and reception point (TRP), or the like, or may be a gNB or a transmission point (for example, a TRP or a TP) in new radio (NR), or one or a group of antenna panels (including a plurality of antenna panels) of a base station in NR, or may be a network node that forms a gNB or a transmission point, for example, a baseband unit (BBU) or a distributed unit (DU). Alternatively, the network device may be a vehicle-mounted device, a wearable device, or a network device in a 5G network, or a network device in an evolved public land mobile network (PLMN), or a network device deployed on a satellite. This is not limited.

The network device has abundant product forms. For example, in a product implementation process, the BBU and a radio frequency unit (RFU) may be integrated into a same device, and the device is connected to an antenna array through a cable (for example, but not limited to a feeder). The BBU and the RFU may alternatively be disposed separately, are connected through an optical fiber, and communicate with each other by using, for example, but not limited to, a common public radio frequency interface (CPRI) protocol. In this case, the RFU is usually referred to as a remote radio unit (RRU), and is connected to the antenna array through the cable. In addition, the RRU may alternatively be integrated with the antenna array. For example, this structure is currently used in an active antenna unit (AAU) product in the market.

In addition, the BBU can be further divided into a plurality of parts. For example, the BBU can be further divided into a central unit (CU) and a distributed unit (DU) based on real-time performance of a processed service. The CU is responsible for processing non-real-time protocols and services, and the DU is responsible for processing physical layer protocols and real-time services. Further, some physical layer functions may be separated from the BBU or the DU and integrated into the AAU.

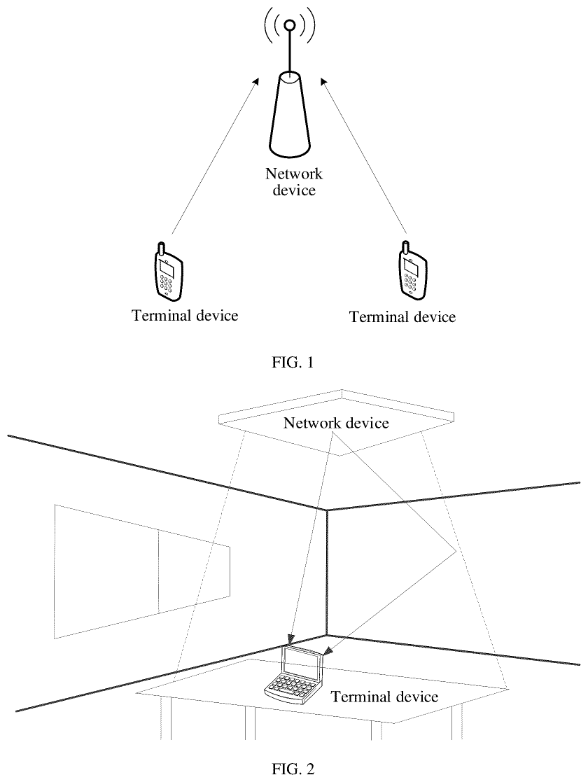

FIG. 1 is a diagram of a system architecture to which an embodiment of this application is applicable. The system includes a network device and a terminal device. Optical communication can be performed between the terminal device and the network device, and the terminal device and the network device are visible (line-of-sight, LOS). The network device includes an AP or a base station.

To facilitate understanding of embodiments of this application, the following briefly describes technical solutions related to embodiments of this application.

Space optical communication is a wireless communication technology. A high-speed and high-bandwidth optical communication system has a bandwidth at a GHz level or a higher level, and uses a multi-carrier modulation technology. In an indoor communication scenario with low-speed mobility and a line of sight, signals are subject to frequency selective fading and block fading. FIG. 2 is a diagram of indoor space optical communication with a line of sight. To implement high-rate data transmission, an optical communication channel having a specific bandwidth needs to be divided into a plurality of sub-channels, and channel quality information of each sub-channel needs to be measured. After obtaining the channel quality information of each sub-channel, a network device adjusts a plurality of transmission-related parameters such as a bandwidth and power resource allocation, modulation, and retransmission, to obtain better signal transmission quality. A WQI and a CQI may represent channel quality.

In an IEEE standard, an optical communication channel is divided into eight sub-channels. The terminal device measures WQIs of the eight sub-channels, and feeds back the WQIs respectively corresponding to the eight sub-channels to the network device. Each fed-back WQI occupies 8 bits. Table 1 shows WQI ranges corresponding to different sub-channels. A channel measurement result/WQI is normalized from 0x00 to 0xff. 0x00 is associated with a lowest WQI of the sub-channel, and 0xff is associated with a highest WQI of the sub-channel.

TABLE 1

| Sub-channel identifier | WQI |
|---|---|
| 0x00 | 0x00 to 0xff |
| 0x01 | 0x00 to 0xff |
| 0x02 | 0x00 to 0xff |
| 0x03 | 0x00 to 0xff |
| 0x04 | 0x00 to 0xff |
| 0x05 | 0x00 to 0xff |
| 0x06 | 0x00 to 0xff |
| 0x07 | 0x00 to 0xff |

This implementation is mainly applicable to a low-bandwidth low-speed space optical communication scenario, and is not applicable to a scenario with high bandwidth and significant channel frequency selective fading. In the scenario with high bandwidth and significant channel frequency selective fading, WQIs of different sub-channels vary greatly. If the WQI fed back by the terminal device to the network device is normalized from 0x00 to 0xff, it is difficult to ensure precision of the fed-back WQI. If the terminal device feeds back an actually measured WQI to the network device, overheads in a feedback process are high.

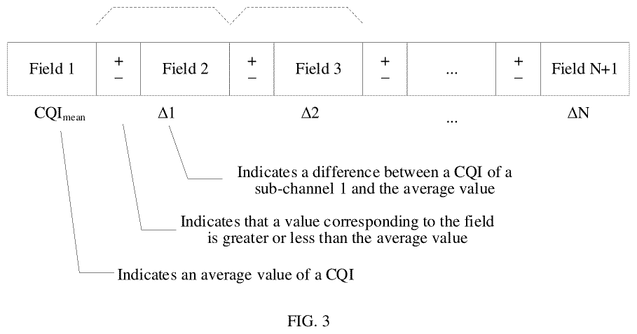

Currently, a channel quality feedback solution based on frequency domain differentiation is provided. In this solution, the terminal device averages CQIs obtained through measurement on all bands/sub-channels to obtain CQIₘₑₐₙ, and then obtains differences between CQIₘₑₐₙ and CQIs of different bands. The terminal device feeds back, to the network device, a difference between a CQI corresponding to each band and CQIₘₑₐₙ. FIG. 3 is a diagram of channel quality fed back based on frequency domain differentiation. In a scenario with high bandwidth and significant channel frequency selective fading, differences between CQIₘₑₐₙ and CQIs of some sub-channels are large. As a result, the differences between CQIₘₑₐₙ and the CQIs of the sub-channels occupy a large quantity of bits, and overheads in a feedback process are also high. Therefore, it is difficult to reduce feedback overheads by using a channel quality feedback solution based on frequency domain differentiation.

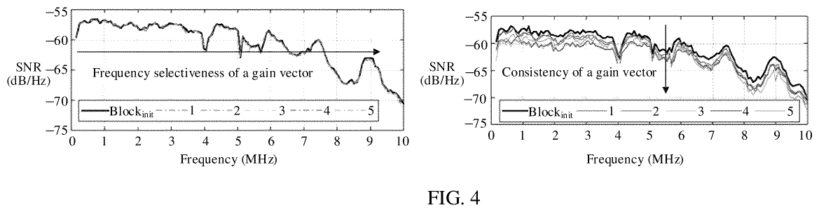

In a high-bandwidth communication scenario in which an indoor terminal device moves at a low speed, a channel gain vector has evident frequency selective fading/frequency selectiveness in frequency domain, and the channel gain vector has evident consistency in time. The channel gain vector includes channel quality information. It may be understood that channel quality information of different bands or sub-channels has a large difference, and channel quality information of a same band or sub-channel changes continuously over time. FIG. 4 is a diagram of relationships between SNRs and channel frequencies in different time units in a quasi-static high-bandwidth communication scenario and a high-bandwidth communication scenario with low-speed mobility. Channel quality information may be represented by using the SNR. Blockᵢₙᵢₜ may be understood as an initial time unit, Block₁ may be understood as a first time unit after the initial time unit, and Block₂ may be understood as a second time unit after the initial time unit.

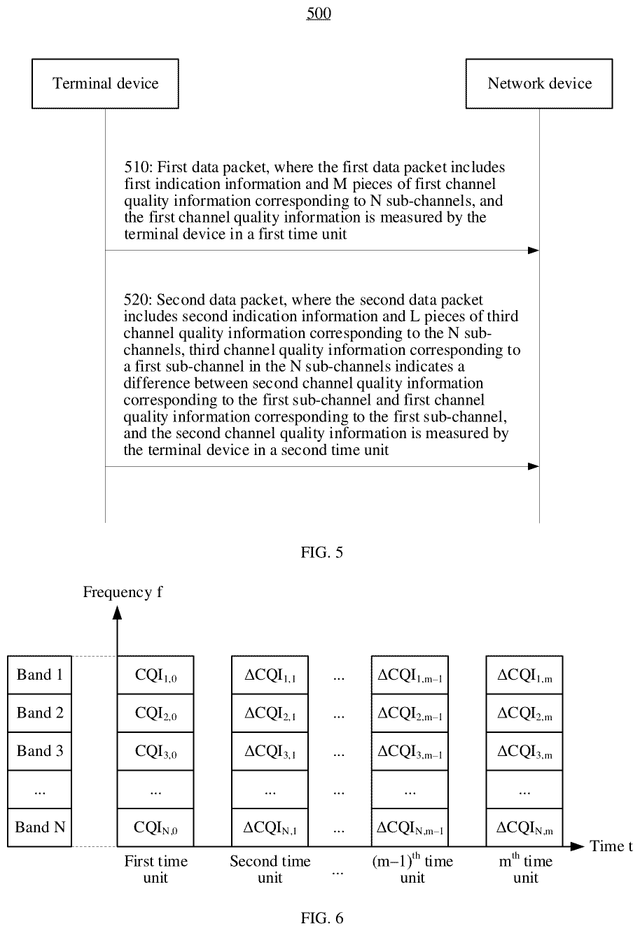

Because channel quality information of a same band or sub-channel changes continuously over time, an embodiment of this application provides a method for feeding back channel quality information. A terminal device feeds back, to a network device in a manner of feeding back channel quality information based on time differentiation, channel quality information of different sub-channels that are obtained through measurement in different time units, so that feedback overheads of the channel quality information can be reduced. Embodiments of this application are applicable to visible optical communication, and are also applicable to millimeter-wave communication over a line-of-sight path. FIG. 5 is a schematic interaction flowchart of a method 500 for feeding back channel quality information according to an embodiment of this application.

510: A terminal device sends a first data packet to a network device, where the first data packet includes first indication information and M pieces of first channel quality information corresponding to N sub-channels, the first indication information indicates that the channel quality information in the first data packet is originally measured channel quality information, the first channel quality information is measured by the terminal device in a first time unit, the N sub-channels are communication channels between the terminal device and the network device, N is an integer greater than 1, and M is a positive integer less than or equal to N. Correspondingly, the network device receives the first data packet from the terminal device.

The originally measured channel quality information may be understood as channel quality information initially measured or channel quality information measured for the first time, or may be understood as actually measured channel quality information on which difference calculation is not performed. In this embodiment of this application, the N sub-channels may correspond to different bands, or the N sub-channels may correspond to different frequency ranges in a same band. This is not specifically limited herein.

Optionally, before the terminal device sends the first data packet to the network device, the terminal device measures, in the first time unit, the first channel quality information respectively corresponding to the N sub-channels. The first time unit in this embodiment of this application may be a slot, a symbol, a frame, a sub-frame, or the like. This is not limited herein.

Optionally, the first data packet further includes third indication information, and the third indication information indicates a quantity of bits of an integer part and a quantity of bits of a fractional part corresponding to the M pieces of first channel quality information. For example, the quantity of bits of the fractional parts corresponding to the M pieces of first channel quality information may be indicated by the network device to the terminal device, may be determined by the terminal device, or may be predefined.

Optionally, the third indication information further indicates a quantity of bits of a sign part corresponding to the M pieces of first channel quality information. The sign part indicates a positive/negative value of the first channel quality information. The M pieces of first channel quality information in the first data packet are encoded by the terminal device and then sent to the network device, and the third indication information is used by the network device to decode the M pieces of first channel quality information in the first data packet, to obtain the decoded first channel quality information respectively corresponding to the N sub-channels.

The M pieces of first channel quality information in the first data packet are M pieces of encoded first channel quality information. For different encoding schemes, a quantity of bits of an integer part, a quantity of bits of a fractional part, and a quantity of bits of a sign part corresponding to the encoded first channel quality information vary.

Optionally, the M pieces of first channel quality information are in one-to-one correspondence with the N sub-channels, and M is equal to N.

Optionally, each of the M pieces of first channel quality information corresponds to at least one second sub-channel in the N sub-channels, different second sub-channels in the at least one second sub-channel have same first channel quality information, or a difference between first channel quality information of different second sub-channels in the at least one second sub-channel is less than or equal to a preset threshold, and M is less than N. The preset threshold may be determined by the terminal device, or may be indicated by the network device to the terminal device. It may be understood that different second sub-channels in the at least one second sub-channel have same or similar first channel quality information.

When a plurality of second sub-channels in the N sub-channels respectively correspond to same or similar first channel quality information, the terminal device needs to feed back only one piece of first channel quality information for the plurality of second sub-channels. Therefore, an amount of first channel quality information that the terminal device needs to feed back to the network device is reduced, to reduce feedback overheads of the channel quality information.

520: The terminal device sends a second data packet to the network device, where the second data packet includes second indication information and L pieces of third channel quality information corresponding to the N sub-channels, third channel quality information corresponding to a first sub-channel in the N sub-channels indicates a difference between second channel quality information corresponding to the first sub-channel and first channel quality information corresponding to the first sub-channel, the second channel quality information is measured by the terminal device in a second time unit, the second indication information indicates that the channel quality information in the second data packet is non-originally measured channel quality information, L is a positive integer less than or equal to N, and the second time unit is later than the first time unit. Correspondingly, the network device receives the second data packet from the terminal device, and determines, based on the third channel quality information corresponding to the N sub-channels and the first channel quality information corresponding to the N sub-channels, second channel quality information respectively corresponding to the N sub-channels. A value of L may be the same as or may be different from a value of M.

For example, the third channel quality information corresponding to the first sub-channel is equal to the difference between the second channel quality information corresponding to the first sub-channel and the first channel quality information corresponding to the first sub-channel, and a quantity of bits occupied by the L pieces of third channel quality information corresponding to the N sub-channels is less than a quantity of bits occupied by the second channel quality information corresponding to the N sub-channels. Therefore, in comparison with directly feeding back the second channel quality information corresponding to the N sub-channels, in this embodiment of this application, the terminal device feeds back the L pieces of third channel quality information to the network device, so that feedback overheads of the channel quality information can be reduced. In comparison with a solution in which a fed-back WQI is normalized from 0x00 to 0xff, in this embodiment of this application, normalization processing is not performed on the fed-back channel quality information, so that precision of the fed-back channel quality information can be ensured. It can be learned from the foregoing that, according to the technical solutions provided in this embodiment of this application, the feedback overheads of the channel quality information can be reduced while precision of the fed-back channel quality information is ensured.

The non-originally measured channel quality information may be understood as channel quality information not initially measured or channel quality information not measured for the first time, or may be understood as channel quality information obtained by performing difference calculation on channel quality information measured this time and channel quality information measured last time.

Optionally, before the terminal device sends the second data packet to the network device, the terminal device measures, in the second time unit, the second channel quality information respectively corresponding to the N sub-channels, and obtains a difference between the second channel quality information of the first sub-channel in the N sub-channels and the first channel quality information of the first sub-channel, to generate the third channel quality information of the first sub-channel. The second time unit in this embodiment of this application may be a slot, a symbol, a frame, a sub-frame, or the like. This is not limited herein.

Optionally, the second data packet further includes fourth indication information, and the fourth indication information indicates a quantity of bits of an integer part and a quantity of bits of a fractional part corresponding to the L pieces of third channel quality information. For example, the quantity of bits of the fractional parts corresponding to the L pieces of third channel quality information may be indicated by the network device to the terminal device, may be determined by the terminal device, or may be predefined.

Optionally, the fourth indication information further indicates a quantity of bits of a sign part corresponding to the L pieces of third channel quality information. The sign part indicates a positive/negative value of the third channel quality information. The L pieces of third channel quality information in the second data packet are encoded by the terminal device and then sent to the network device, and the fourth indication information is used by the network device to decode the L pieces of third channel quality information in the second data packet, to obtain the decoded third channel quality information respectively corresponding to the N sub-channels.

The L pieces of third channel quality information in the second data packet are L pieces of encoded third channel quality information. For different encoding schemes, a quantity of bits of an integer part, a quantity of bits of a fractional part, and a quantity of bits of a sign part corresponding to the encoded third channel quality information vary.

Optionally, the L pieces of third channel quality information are in one-to-one correspondence with the N sub-channels, and L is equal to N.

Optionally, each of the L pieces of third channel quality information corresponds to at least one third sub-channel in the N sub-channels, different third sub-channels in the at least one third sub-channel have same third channel quality information, or a difference between the third channel quality information of different third sub-channels in the at least one third sub-channel is less than or equal to the preset threshold, and L is less than N. The preset threshold may be determined by the terminal device, or may be indicated by the network device to the terminal device. It may be understood that different third sub-channels in the at least one third sub-channel have same or similar third channel quality information.

When a plurality of third sub-channels in the N sub-channels respectively correspond to same or similar third channel quality information, the terminal device needs to feed back only one piece of third channel quality information for the plurality of third sub-channels. Therefore, an amount of third channel quality information that the terminal device needs to feed back to the network device is reduced, to reduce feedback overheads of the channel quality information.

For example, the first channel quality information, the second channel quality information, and the third channel quality information in this embodiment of this application include a CQI or a WQI.

Optionally, if a total quantity of bits corresponding to the L pieces of third channel quality information is less than a total quantity of bits of second channel quality information corresponding to the N sub-channels, the terminal device sends the second data packet to the network device. It should be understood that “if . . . ” in this embodiment of this application may be replaced with “if . . . ” or “when . . . ”. This is not specifically limited in embodiments of this application.

Optionally, if the total quantity of bits corresponding to the L pieces of third channel quality information is greater than or equal to the total quantity of bits of the second channel quality information corresponding to the N sub-channels, the terminal device sends a third data packet to the network device, where the third data packet includes seventh indication information and the second channel quality information corresponding to the N sub-channels, and the seventh indication information indicates that the channel quality information in the third data packet is originally measured channel quality information. Correspondingly, the network device receives the third data packet from the terminal device. A smaller total quantity of bits corresponding to all channel quality information in a data packet sent by the terminal device to the network device indicates lower required transmission overheads, so that transmission resources can be saved.

Optionally, the third data packet further includes eighth indication information, and the eighth indication information indicates a quantity of bits of an integer part, a quantity of bits of a fractional part, and a quantity of bits of a sign part corresponding to the second channel quality information corresponding to the N sub-channels. Optionally, the third data packet further includes ninth indication information, and the ninth indication information indicates a sequence number of the third data packet.

After the terminal device sends the third data packet to the network device, the terminal device measures, in a third time unit, fourth channel quality information corresponding to the N sub-channels; and the terminal device sends a fourth data packet to the network device, where fifth channel quality information corresponding to the N sub-channels in the fourth data packet is non-originally measured channel quality information, fifth channel quality information corresponding to the first sub-channel in the N sub-channels is equal to a difference between fourth channel quality information corresponding to the first sub-channel and the second channel quality information corresponding to the first sub-channel, and the third time unit is later than the second time unit.

Optionally, if an absolute value of a value corresponding to third channel quality information of a fourth sub-channel in the N sub-channels is less than an absolute value of a value corresponding to second channel quality information corresponding to the fourth sub-channel, the terminal device sends the second data packet to the network device.

Optionally, if the absolute value of the value corresponding to the third channel quality information of the fourth sub-channel in the N sub-channels is greater than or equal to the absolute value of the value corresponding to the second channel quality information corresponding to the fourth sub-channel, the terminal device sends the third data packet to the network device. If the absolute value of the value of the third channel quality information corresponding to the fourth sub-channel in the N sub-channels is greater than or equal to the absolute value of the value of the second channel quality information corresponding to the fourth sub-channel, it indicates that an error occurs in non-originally measured channel quality information (the third channel quality information) determined by the terminal device. In this case, the terminal device sends the third data packet (the originally measured second channel quality information) to the network device, so that accuracy of the channel quality information obtained by the network device can be improved.

Optionally, the first data packet further includes fifth indication information, and the fifth indication information indicates a sequence number of the first data packet. The second data packet further includes sixth indication information, and the sixth indication information indicates a sequence number of the second data packet. Data packets sent by the terminal device to the network device are numbered by using sequence numbers, and sequence numbers of two adjacent data packets sent by the terminal device are consecutive. If a sequence number of a data packet received by the network device this time and a sequence number of a data packet received last time are inconsecutive, it indicates that a packet loss occurs, and the network device may determine that a bit error occurs in the channel quality information sent by the terminal device.

Optionally, the network device sends first instruction information to the terminal device, where the first instruction information indicates the terminal device to send a data packet corresponding to the originally measured channel quality information. For example, if the network device determines that a bit error occurs in the third channel quality information in the second data packet, the network device sends the first instruction information to the terminal device, where the first instruction information indicates the terminal device to send the data packet corresponding to the originally measured channel quality information. Correspondingly, the terminal device receives the first instruction information from the network device. The terminal device measures, in the third time unit, the fourth channel quality information corresponding to the N sub-channels. The terminal device sends a fifth data packet to the network device, where the fourth channel quality information corresponding to the N sub-channels in the fifth data packet is originally measured channel quality information, and the third time unit is later than the second time unit. The terminal device measures, in a fourth time unit, sixth channel quality information corresponding to the N sub-channels; and the terminal device sends a sixth data packet to the network device, where seventh channel quality information corresponding to the N sub-channels in the sixth data packet is non-originally measured channel quality information, seventh channel quality information corresponding to the first sub-channel in the N sub-channels is equal to a difference between sixth channel quality information corresponding to the first sub-channel and the fourth channel quality information corresponding to the first sub-channel, and the fourth time unit is later than the third time unit.

For example, the network device may detect a signal-to-noise ratio level of an uplink between the terminal device and the network device within a period of time. If it is determined that the channel quality information in the second data packet sent by the terminal device does not match or has a large error with the detected signal-to-noise ratio level of the uplink, the network device sends the first instruction information to the terminal device. For example, if the network device determines that the sequence number of the second data packet received this time and the sequence number of the data packet received last time are inconsecutive, the network device sends the first instruction information to the terminal device.

When the network device determines that a bit error occurs in the third channel quality information in the second data packet, the network device sends the first instruction information to the terminal device, where the first instruction information indicates the terminal device to send the data packet of the originally measured channel quality information, so that accuracy of the channel quality information obtained by the network device can be improved.

With reference to specific examples, the following describes a method for feeding back channel quality information provided in an embodiment of this application.

Example 1: A terminal device sends, to a network device, channel quality information respectively corresponding to N sub-channels, where the channel quality information is in one-to-one correspondence with the sub-channels. A specific process is as follows.

Step 1: The terminal device measures, in a first time unit, CQI_{n,0} respectively corresponding to the N sub-channels, where n=1, 2, 3, . . . , or N.

Step 2: The terminal device performs fixed-point encoding on CQI_{n,0}, where a quantity of bits of an integer part corresponding to CQI_{n,0} is related to a value range of CQI_{n,0}, and a quantity of bits of a fractional part corresponding to CQI_{n,0} is related to a quantization error of CQI_{n,0}.

Step 3: The terminal device sends a first data packet to the network device, where the first data packet includes encoded CQI_{n,0}, . . . , and CQI_{N,0}, the first data packet includes first indication information and third indication information, the first indication information indicates that CQI_{n,0} in the first data packet is originally measured channel quality information, and the third indication information indicates a quantity of bits of a sign part, a quantity of bits of an integer part, and a quantity of bits of a fractional part corresponding to CQI_{n,0}. Correspondingly, the network device receives the first data packet from the terminal device.

The first indication information may be indicated by using a “state” field. When a value of the “state” field is 0, it indicates CQI_{n,0} in the first data packet is the originally measured channel quality information. The N sub-channels may be referred to as N bands, and N sub-channel identifiers may be indicated as N band codes (BC). Table 2 and Table 3 are examples of formats of the first data packet. N=127. [1,7,3] indicated by the third indication information indicates that the quantity of bits of the sign part corresponding to encoded CQI_{n,0} is 1, the quantity of bits of the integer parts corresponding to encoded CQI_{n,0} is 7, and the quantity of bits of the fractional parts corresponding to encoded CQI_{n,0} is 3.

TABLE 2

| BC | State = 0 | BC1 | BC2 | . . . | BC126 | BC127 |
|---|---|---|---|---|---|---|
| CQI | The third | 10111011100 | 10111001100 | . . . | 11000110001 | 11000110011 |
| | indication | | | | | |
| | information | | | | | |
| | indicates | | | | | |
| | [1, 7, 3] | | | | | |

TABLE 3

| BC | State = 0 | BC1 | BC2 | . . . | BC126 | BC127 |
|---|---|---|---|---|---|---|
| CQI | The third | 10111011101 | 10111001100 | . . . | 11000101001 | 11000110100 |
| | indication | | | | | |
| | information | | | | | |
| | indicates | | | | | |
| | [1, 7, 3] | | | | | |

Step 4: The terminal device measures, in an m^{th} time unit, CQI_{n,m} respectively corresponding to the N sub-channels. n=1, 2, 3, . . . , or N, and m is an integer greater than 1.

Step 5: The terminal device determines a difference between channel quality information measured in the m^{th} time unit and channel quality information measured in an (m−1)^{th} time unit that correspond to each sub-channel: ΔCQI_{n,m}=CQI_{n,m}−CQI_{n,m-1}. The terminal device needs to store CQI_{n,m-1} measured in the (m−1)^{th} time unit, and can delete CQI_{n,m-1} only after determining CQI_{n,m}.

Step 6: The terminal device performs fixed-point encoding on ΔCQI_{n,m}, where a quantity of bits of an integer part corresponding to ΔCQI_{n,m} is related to a value range of ΔCQI_{n,m}, and a quantity of bits of a fractional part corresponding to ΔCQI_{n,m} is related to a quantization error of ΔCQI_{n,m}.

Step 7: The terminal device sends a second data packet to the network device, where the second data packet includes encoded ΔCQI_{1,m}, ΔCQI_{2,m}, . . . , ΔCQI_{n,m}, . . . , and ΔCQI_{N,m}, the second data packet includes second indication information and fourth indication information, the second indication information indicates that ΔCQI_{n,m} in the second data packet is non-originally measured channel quality information, and the fourth indication information indicates a quantity of bits of a sign part, a quantity of bits of an integer part, and a quantity of bits of a fractional part corresponding to ΔCQI_{n,m}.

The second indication information may be indicated by using a “state” field. When a value of the “state” field is 1, it indicates that ΔCQI_{n,m} in the second data packet is the non-originally measured channel quality information. Table 4 and Table 5 are examples of formats of the second data packet. N=127. A maximum quantization error of ΔCQI_{n,m} is 1/16. In Table 4, [1,1,3] indicated by the fourth indication information indicates that the quantity of bits of the sign part corresponding to encoded ΔCQI_{n,m} is 1, the quantity of bits of the integer parts corresponding to encoded ΔCQI_{n,m} is 1, and the quantity of bits of the fractional parts corresponding to encoded ΔCQI_{n,m} is 3. In Table 5, [1,2,3] indicated by the fourth indication information indicates that the quantity of bits of the sign part corresponding to encoded ΔCQI_{n,m} is 1, the quantity of bits of the integer parts corresponding to encoded ΔCQI_{n,m} is 2, and the quantity of bits of the fractional parts corresponding to encoded ΔCQI_{n,m} is 3.

TABLE 4

| BC | State = 1 | BC1 | BC2 | . . . | BC126 | BC127 |
|---|---|---|---|---|---|---|
| ACQI | The fourth | 10001 | 10000 | . . . | 00000 | 00010 |
| | indication | | | | | |
| | information | | | | | |
| | indicates | | | | | |
| | [1, 1, 3] | | | | | |

TABLE 5

| BC | State = 1 | BC1 | BC2 | . . . | BC126 | BC127 |
|---|---|---|---|---|---|---|
| ACQI | The fourth | 101101 | 101000 | . . . | 101001 | 100110 |
| | indication | | | | | |
| | information | | | | | |
| | indicates | | | | | |
| | [1, 2, 3] | | | | | |

Step 8: The network device receives the second data packet from the terminal device, and the network device may determine, based on the second indication information in the second data packet, that the channel quality information in the second data packet is the non-originally measured channel quality information. In this case, the network device determines CQI_{n,m} based on ΔCQI_{n,m} in the second data packet and stored CQI_{n,m-1}, and performs resource scheduling based on CQI_{n,m}. The network device needs to store CQI_{n,m-1} obtained last time, and can delete CQI_{n,m-1} only after receiving ΔCQI_{n,m} and determining CQI_{n,m}.

In step 5 and step 6, the terminal device may determine whether the originally measured channel quality information needs to be sent to the network device. If a total quantity of bits of N pieces of information of ΔCQI_{n,m} is less than a total quantity of bits of N pieces of information of CQI_{n,m}, the terminal device sends the non-originally measured channel quality information ΔCQI_{n,m} to the network device. In this case, state=1. If the total quantity of bits of the N pieces of information of ΔCQI_{n,m} is greater than or equal to the total quantity of bits of the N pieces of information of CQI_{n,m}, the terminal device sends the originally measured channel quality information CQI_{n,m} to the network device. In this case, state=0. When the terminal device sends the originally measured channel quality information to the network device in the m^{th} time unit, the terminal device sends the non-originally measured channel quality information ΔCQI_{n,m+1} to the network device in the (m+1)^{th} time unit, and state=1.

In step 8, the network device may determine whether the terminal device needs to send the originally measured channel quality information. For example, if a bit error occurs in ΔCQI_{n,m} received by the network device, and the network device determines that the terminal device needs to send the originally measured channel quality information, the network device sends first instruction information to the terminal device, where the first instruction information indicates the terminal device to send the originally measured channel quality information. Correspondingly, the terminal device receives the first instruction information from the network device, and the terminal device sends originally measured channel quality information CQI_{n,m+1} to the network device in the (m+1)^{th} time unit. In this case, state=0. The terminal device sends non-originally measured channel quality information ΔCQI_{n,m+2} to the network device in the (m+2)^{th} time unit. In this case, state=1.

FIG. 6 is a diagram of sending, by a terminal device, channel quality information to a network device in different time units according to an embodiment of this application. In a first time unit, the terminal device sends, to the network device, originally measured channel quality information CQI_{n,0} corresponding to N bands/sub-channels. In an m^{th} time unit, the terminal device sends, to the network device, non-originally measured channel quality information ΔCQI_{n,m} corresponding to the N bands/sub-channels.

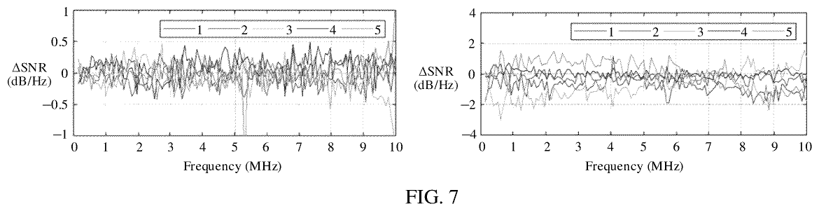

FIG. 7 is a diagram of relationships between ΔSNR and frequencies that are fed back by a terminal device to a network device in different time units according to an embodiment of this application. Channel quality information may be represented by using an SNR. “1, 2, 3, 4, and 5” in FIG. 7 indicate the different time units. It can be learned that values of ΔSNR corresponding to different bands are small. Therefore, a quantity of bits of ΔSNR fed back by the terminal device to the network device is also small, so that feedback overheads of the channel quality information can be reduced.

Example 2: A terminal device feeds back channel quality information of N sub-channels to a network device in groups. When a plurality of sub-channels in the N sub-channels respectively correspond to same or similar channel quality information, the plurality of sub-channels are a group of sub-channels, and the terminal device needs to feed back only one piece of channel quality information for the group of sub-channels. Therefore, an amount of channel quality information that the terminal device needs to feed back to the network device is reduced, to reduce feedback overheads of the channel quality information. A specific process is as follows.

Step 1: The terminal device measures, in a first time unit, CQI_{n,0} respectively corresponding to the N sub-channels, where n=1, 2, 3, . . . , or N.

Step 2: The terminal device performs fixed-point encoding on CQI_{n,0}, where a quantity of bits of an integer part corresponding to CQI_{n,0} is related to a value range of CQI_{n,0}, and a quantity of bits of a fractional part corresponding to CQI_{n,0} is related to a quantization error of CQI_{n,0}.

Step 3: The terminal device groups CQI_{n,0} respectively corresponding to the N sub-channels, where a plurality of sub-channels with a same CQI or similar CQIs are a group of sub-channels, and only one CQI needs to be fed back for the group of sub-channels.

Step 4: The terminal device sends a first data packet to the network device, where the first data packet includes encoded CQI_{n,0} corresponding to each group of sub-channels, first indication information, and third indication information. The first indication information indicates CQI_{n,0} in the first data packet is originally measured channel quality information, and the third indication information indicates a quantity of bits of a sign part, a quantity of bits of an integer part, and a quantity of bits of a fractional part corresponding to CQI_{n,0} in the first data packet. Correspondingly, the network device receives the first data packet from the terminal device.

Table 6 and Table 7 are examples of formats of the first data packet. N=127. [1,7,3] indicated by the third indication information indicates that the quantity of bits of the sign part corresponding to encoded CQI_{n,0} is 1, the quantity of bits of the integer parts corresponding to encoded CQI_{n,0} is 7, and the quantity of bits of the fractional parts corresponding to encoded CQI_{n,0} is 3. The terminal device obtains 127 CQIs of 127 sub-channels through measurement. In Table 6, after the 127 sub-channels are grouped, the terminal device needs to feed back only 68 CQIs corresponding to 68 groups of sub-channels to the network device. In Table 7, after the 127 sub-channels are grouped, the terminal device needs to feed back only 66 CQIs corresponding to 66 groups of sub-channels to the network device.

TABLE 6

| BC | State = 0 | BC1: 1, 65, 77 | BC2: 2, 15, 29 | . . . | BC67: 126 | BC68: 127 |
|---|---|---|---|---|---|---|
| CQI | The third | 10111011100 | 10111001100 | . . . | 11000110001 | 11000110011 |
| | indication | | | | | |
| | information | | | | | |
| | indicates | | | | | |
| | [1, 7, 3] | | | | | |

TABLE 7

| BC | State = 0 | BC1: 1, 65, 77 | BC2: 2, 15, 29 | . . . | BC67: 126 | BC68: 127 |
|---|---|---|---|---|---|---|
| CQI | The third | 10111011100 | 10111001100 | . . . | 11000101001 | 11000110100 |
| | indication | | | | | |
| | information | | | | | |
| | indicates | | | | | |
| | [1, 7, 3] | | | | | |

Step 5: The terminal device measures, in an m^{th} time unit, CQI_{n,m} respectively corresponding to the N sub-channels. n=1, 2, 3, . . . , or N, and m is an integer greater than 1.

Step 6: The terminal device determines a difference between channel quality information measured in the m^{th} time unit and channel quality information measured in an (m−1)^{th} time unit that correspond to each sub-channel: ΔCQI_{n,m}=CQI_{n,m}−CQI_{n,m-1}. The terminal device needs to store CQI_{n,m-1} measured in the (m−1)^{th} time unit, and can delete CQI_{n,m-1} only after determining CQI_{n,m}.

Step 7: The terminal device performs fixed-point encoding on ΔCQI_{n,m}, where a quantity of bits of an integer part corresponding to ΔCQI_{n,m} is related to a value range of ΔCQI_{n,m}, and a quantity of bits of a fractional part corresponding to ΔCQI_{n,m} is related to a quantization error of ΔCQI_{n,m}.

Step 8: The terminal device groups ΔCQI_{n,m} respectively corresponding to the N sub-channels, where a plurality of sub-channels with same or similar ΔCQI are a group of sub-channels, and only one piece of information of ΔCQI needs to be fed back for the group of sub-channels.

Step 9: The terminal device sends a second data packet to the network device, where the second data packet includes encoded ΔCQI_{n,m} corresponding to each group of sub-channels, second indication information, and fourth indication information. The second indication information indicates that ΔCQI_{n,m} in the second data packet is non-originally measured channel quality information, and the fourth indication information indicates a quantity of bits of a sign part, a quantity of bits of an integer part, and a quantity of bits of a fractional part corresponding to ΔCQI_{n,m}.

Table 8 and Table 9 are examples of formats of the second data packet. N=127. A maximum quantization error of ΔCQI_{n,m} is 1/16. If sub-channels with ΔCQI_{n,m} changing within a preset threshold of 6=0.125 are grouped into one group, the quantity of bits of the fractional parts corresponding to ΔCQI_{n,m} is 3. In Table 8, [1,1,3] indicated by the fourth indication information indicates that the quantity of bits of the sign part corresponding to encoded ΔCQI_{n,m} is 1, the quantity of bits of the integer parts corresponding to encoded ΔCQI_{n,m} is 1, and the quantity of bits of the fractional parts corresponding to encoded ΔCQI_{n,m} is 3. In Table 9, [1,2,3] indicated by the fourth indication information indicates that the quantity of bits of the sign part corresponding to encoded ΔCQI_{n,m} is 1, the quantity of bits of the integer parts corresponding to encoded ΔCQI_{n,m} is 2, and the quantity of bits of the fractional parts corresponding to encoded ΔCQI_{n,m} is 3. The terminal device obtains 127 pieces of information of ΔCQI_{n,m} of 127 sub-channels through measurement. In Table 8, after the 127 sub-channels are grouped, the terminal device needs to feed back only nine pieces of information of ΔCQI corresponding to nine groups of sub-channels to the network device. In Table 9, after the 127 sub-channels are grouped, the terminal device needs to feed back only 22 pieces of information of ΔCQI corresponding to 22 groups of sub-channels to the network device. This can greatly reduce overheads of feeding back the channel quality information.

TABLE 8

| | | BC1: 1, 4, | BC2: 2, | | | |
|---|---|---|---|---|---|---|
| BC | State = 1 | 12, . . . | 13, . . . | . . . | BC8: 86 | BC9: 115 |
| CQI | The fourth | 10001 | 00011 | . . . | 00000 | 10100 |
| | indication | | | | | |
| | information | | | | | |
| | indicates | | | | | |
| | [1, 1, 3] | | | | | |

TABLE 9

| | | | BC2: 2, 7, | | | |
|---|---|---|---|---|---|---|
| BC | State = 1 | BC1: 1 | 36, ... | . . . | BC21: 76 | BC22: 106 |
| CQI | The fourth | 101101 | 101000 | . . . | 000010 | 101111 |
| | indication | | | | | |
| | information | | | | | |
| | indicates | | | | | |
| | [1, 2, 3] | | | | | |

Step 10: The network device receives the second data packet from the terminal device, and the network device may determine, based on the second indication information in the second data packet, that channel quality information in the second data packet is non-originally measured channel quality information. In this case, the network device determines CQI_{n,m} based on ΔCQI_{n,m} in the second data packet and stored CQI_{n,m-1}, and performs resource scheduling based on CQI_{n,m}. The network device needs to store CQI_{n,m-1} obtained last time, and can delete CQI_{n,m-1} only after receiving ΔCQI_{n,m} and determining CQI_{n,m}.

In a high-bandwidth communication scenario in which an indoor terminal device moves at a low speed, for example, a quantization error of channel quality information is 0.0625, and a preset threshold of a difference between channel quality information of different sub-channels in a group of sub-channels is 0.125 dB/Hz. For channel quality information measured by the terminal device in different time units, if a channel quality feedback solution provided in an IEEE standard is used, an example of a format of a data packet sent by the terminal device to the network device is shown in Table 10. If a grouped channel quality feedback solution based on frequency domain differentiation is used, an example of a format of a data packet sent by the terminal device to the network device is shown in Table 11. If a grouped channel quality feedback solution provided in this embodiment of this application is used, an example of a format of a data packet sent by the terminal device to the network device is shown in Table 12.

TABLE 10

| BC | State = 0 | BC1 | BC2 | . . . | BC126 | BC127 |
|---|---|---|---|---|---|---|
| CQI | [1, 7, 3] | 10111011100 | 10111001100 | . . . | 11000101001 | 11000110100 |

TABLE 11

| BC | \ | CQIₘₑₐₙ | BC1: 1, 79 | . . . | BC68: 126 | BC69: 127 |
|---|---|---|---|---|---|---|
| ΔCQI | [1, 6, 3] | 1111101110 | 1000000101 | . . . | 1001001011 | 1001010100 |

TABLE 12

| | | | BC2: 2, 7, | | | |
|---|---|---|---|---|---|---|
| BC | State = 1 | BC1: 1 | 36, . . . | . . . | BC21: 76 | BC22: 106 |
| ΔCQI | [1, 2, 3] | 101101 | 101000 | . . . | 000010 | 101111 |

It can be learned that feedback overheads of the channel quality feedback solution provided in the IEEE standard are 127*(1+7+3)=1397 bits, feedback overheads of the grouped channel quality feedback solution based on frequency domain differentiation are 66*(1+6+3)=660 bits, and feedback overheads of the grouped channel quality feedback solution provided in this embodiment of this application may be 22*(1+2+3)=132 bits. Therefore, the grouped channel quality feedback solution provided in this embodiment of this application can reduce feedback overheads of channel quality information.

The foregoing describes the method for feeding back channel quality information provided in embodiments of this application. The following describes an execution entity configured to perform the foregoing method for feeding back channel quality information.

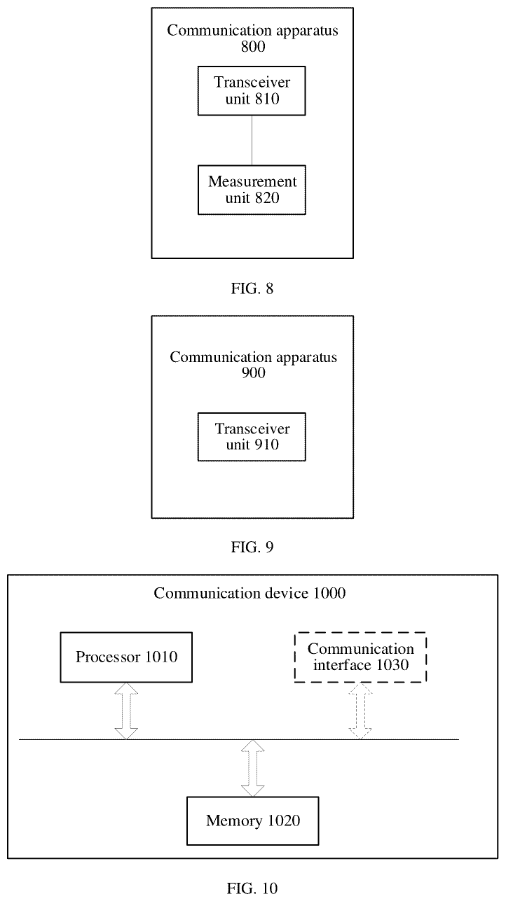

FIG. 8 is a block diagram of a communication apparatus 800 according to an embodiment of this application. The apparatus may be used in the terminal device in embodiments of this application. The communication apparatus 800 includes:
a transceiver unit 810, configured to send a first data packet to a network device, where the first data packet includes first indication information and M pieces of first channel quality information corresponding to N sub-channels, the first indication information indicates that the channel quality information in the first data packet is originally measured channel quality information, the first channel quality information is measured in a first time unit, the N sub-channels are communication channels between the apparatus and the network device, N is an integer greater than 1, and M is a positive integer less than or equal to N.

The transceiver unit 810 is further configured to send a second data packet to the network device, where the second data packet includes second indication information and L pieces of third channel quality information corresponding to the N sub-channels, third channel quality information corresponding to a first sub-channel in the N sub-channels indicates a difference between second channel quality information corresponding to the first sub-channel and first channel quality information corresponding to the first sub-channel, the second channel quality information is measured in a second time unit, the second indication information indicates that the channel quality information in the second data packet is non-originally measured channel quality information, L is a positive integer less than or equal to N, and the second time unit is later than the first time unit.

Optionally, the first data packet further includes third indication information, and the third indication information indicates a quantity of bits of an integer part and a quantity of bits of a fractional part corresponding to the M pieces of first channel quality information. The second data packet further includes fourth indication information, and the fourth indication information indicates a quantity of bits of an integer part and a quantity of bits of a fractional part corresponding to the L pieces of third channel quality information.

Optionally, the third indication information further indicates a quantity of bits of a sign part corresponding to the M pieces of first channel quality information; and the fourth indication information further indicates a quantity of bits of a sign part corresponding to the L pieces of third channel quality information.

Optionally, the third channel quality information corresponding to the first sub-channel is equal to the difference between the second channel quality information corresponding to the first sub-channel and the first channel quality information corresponding to the first sub-channel.

Optionally, the M pieces of first channel quality information are in one-to-one correspondence with the N sub-channels, and M is equal to N; or each of the M pieces of first channel quality information corresponds to at least one second sub-channel in the N sub-channels, different second sub-channels in the at least one second sub-channel have same first channel quality information, and M is less than N.

Optionally, the L pieces of third channel quality information are in one-to-one correspondence with the N sub-channels, and L is equal to N; or each of the L pieces of third channel quality information corresponds to at least one third sub-channel in the N sub-channels, different third sub-channels in the at least one third sub-channel have same third channel quality information, and L is less than N.

Optionally, the first data packet further includes fifth indication information, and the fifth indication information indicates a sequence number of the first data packet. The second data packet further includes sixth indication information, and the sixth indication information indicates a sequence number of the second data packet.

Optionally, the transceiver unit 810 is further configured to receive first instruction information from the network device, where the first instruction information indicates to send a data packet corresponding to the originally measured channel quality information.

Optionally, the transceiver unit 810 is specifically configured to: if a total quantity of bits corresponding to the L pieces of third channel quality information is less than a total quantity of bits of second channel quality information corresponding to the N sub-channels, send the second data packet to the network device.

Optionally, the transceiver unit 810 is further configured to: if the total quantity of bits corresponding to the L pieces of third channel quality information is greater than or equal to the total quantity of bits of the second channel quality information corresponding to the N sub-channels, send a third data packet to the network device, where the third data packet includes seventh indication information and the second channel quality information corresponding to the N sub-channels, and the seventh indication information indicates that the channel quality information in the third data packet is originally measured channel quality information.

Optionally, the apparatus further includes a measurement unit 820. The measurement unit 820 is configured to measure, in the first time unit, the first channel quality information respectively corresponding to the N sub-channels; and/or the measurement unit 820 is configured to measure, in the second time unit, the second channel quality information respectively corresponding to the N sub-channels.

Optionally, the first channel quality information includes a CQI or a WQI; the second channel quality information includes a CQI or a WQI; and the third channel quality information includes a CQI or a WQI.

FIG. 9 is a block diagram of a communication apparatus 900 according to an embodiment of this application. The apparatus may be used in the network device in embodiments of this application. The communication apparatus 900 includes:
a transceiver unit 910, configured to receive a first data packet from a terminal device, where the first data packet includes first indication information and M pieces of first channel quality information corresponding to N sub-channels, the first indication information indicates that the channel quality information in the first data packet is originally measured channel quality information, the first channel quality information is measured by the terminal device in a first time unit, the N sub-channels are communication channels between the terminal device and the apparatus, N is an integer greater than 1, and M is a positive integer less than or equal to N.

The transceiver unit 910 is further configured to receive a second data packet from the terminal device, where the second data packet includes second indication information and L pieces of third channel quality information corresponding to the N sub-channels, third channel quality information corresponding to a first sub-channel in the N sub-channels indicates a difference between second channel quality information corresponding to the first sub-channel and first channel quality information corresponding to the first sub-channel, the second channel quality information is measured by the terminal device in a second time unit, the second indication information indicates that the channel quality information in the second data packet is non-originally measured channel quality information, L is a positive integer less than or equal to N, and the second time unit is later than the first time unit.

Optionally, the first data packet further includes third indication information, and the third indication information indicates a quantity of bits of an integer part and a quantity of bits of a fractional part corresponding to the M pieces of first channel quality information. The second data packet further includes fourth indication information, and the fourth indication information indicates a quantity of bits of an integer part and a quantity of bits of a fractional part corresponding to the L pieces of third channel quality information.

Optionally, the third indication information further indicates a quantity of bits of a sign part corresponding to the M pieces of first channel quality information; and the fourth indication information further indicates a quantity of bits of a sign part corresponding to the L pieces of third channel quality information.

Optionally, the third channel quality information corresponding to the first sub-channel is equal to the difference between the second channel quality information corresponding to the first sub-channel and the first channel quality information corresponding to the first sub-channel.

Optionally, the M pieces of first channel quality information are in one-to-one correspondence with the N sub-channels, and M is equal to N; or each of the M pieces of first channel quality information corresponds to at least one second sub-channel in the N sub-channels, different second sub-channels in the at least one second sub-channel have same first channel quality information, and M is less than N.

Optionally, the L pieces of third channel quality information are in one-to-one correspondence with the N sub-channels, and L is equal to N; or each of the L pieces of third channel quality information corresponds to at least one third sub-channel in the N sub-channels, different third sub-channels in the at least one third sub-channel have same third channel quality information, and L is less than N.

Optionally, the first data packet further includes fifth indication information, and the fifth indication information indicates a sequence number of the first data packet. The second data packet further includes sixth indication information, and the sixth indication information indicates a sequence number of the second data packet.

Optionally, the transceiver unit 910 is further configured to send first instruction information to the terminal device, where the first instruction information indicates the terminal device to send a data packet corresponding to the originally measured channel quality information.

Optionally, the transceiver unit 910 is further configured to receive a third data packet from the terminal device, where the third data packet includes seventh indication information and second channel quality information corresponding to the N sub-channels, and the seventh indication information indicates that the channel quality information in the third data packet is originally measured channel quality information.

FIG. 10 is a block diagram of a communication device 1000 according to an embodiment of this application. The communication device 1000 includes a processor 1010, a memory 1020, and a communication interface 1030.

The memory 1020 is configured to store executable instructions.

The processor 1010 is coupled to the memory 1020 through the communication interface 1030. The processor 1010 is configured to invoke and run the executable instructions in the memory 1020, to implement the method in embodiments of this application. The communication device may be the terminal device or the network device in embodiments of this application. Optionally, the processor 1010 and the memory 1020 are integrated together.

The processor 1010 may be an integrated circuit chip and has a signal processing capability. In an implementation process, steps in the foregoing method embodiments may be implemented by using an integrated logic circuit of hardware in the processor, or by using instructions in a form of software. The processor may be a general-purpose processor, a digital signal processor (DSP), an application specific integrated circuit (ASIC), a field programmable gate array (FPGA), or another programmable logic device, a discrete gate or a transistor logic device, or a discrete hardware component. The methods, steps, and logical block diagrams disclosed in embodiments of this application may be implemented or performed. The general-purpose processor may be a microprocessor, or the processor may be any conventional processor or the like. The steps in the methods disclosed with reference to embodiments of this application may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

Optionally, an embodiment of this application further provides a communication device. The communication device includes an input/output interface and a logic circuit. The input/output interface is configured to obtain input information and/or output information. The logic circuit is configured to perform the method in any one of the foregoing method embodiments, and perform processing and/or generate the output information based on the input information.

An embodiment of this application further provides a communication system, including the terminal device and the network device in any one of the foregoing method embodiments.

An embodiment of this application further provides a computer-readable storage medium. The computer-readable storage medium stores a computer program configured to implement the method in the foregoing method embodiments. When the computer program is run on a computer, the computer is enabled to implement the method in the foregoing method embodiments.

An embodiment of this application further provides a computer program product. The computer program product includes computer program code. When the computer program code is run on a computer, the method in the foregoing method embodiments is performed.

An embodiment of this application further provides a chip, including a processor. The processor is connected to a memory, the memory is configured to store a computer program, and the processor is configured to execute the computer program stored in the memory, to enable the chip to perform the method in the foregoing method embodiments.

It should be understood that, in embodiments of this application, numbers “first”, “second”, and the like are merely used to distinguish between different objects, for example, to distinguish between different sub-channels or different channel quality information, and do not constitute a limitation on the scope of embodiments of this application. This is not limited in embodiments of this application.

In addition, the term “and/or” in this application describes only an association relationship for describing associated objects and indicates that three relationships may exist. For example, A and/or B may indicate the following three cases: Only A exists, both A and B exist, and only B exists. In addition, the character “/” in this specification generally indicates an “or” relationship between associated objects. In this application, the term “at least one” may indicate “one” and “two or more”. For example, A, B, and C may indicate the following seven cases: Only A exists, only B exists, only C exists, both A and B exist, both A and C exist, both C and B exist, and A, B and C all exist.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for detailed working processes of the foregoing systems, apparatuses, and units, refer to corresponding processes in the foregoing method embodiments. Details are not described herein again.

In the several embodiments provided in this application, it should be understood that the disclosed system, apparatus, and method may be implemented in other manners. For example, the described apparatus embodiments are merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to a conventional technology, or some of the technical solutions may be implemented in a form of a software product. The computer software product is stored in a storage medium, and includes several instructions for indicating a computer device (which may be a personal computer, a server, a network device, or the like) to perform all or some of the steps of the methods described in embodiments of this application. The foregoing storage medium includes a medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for feeding back channel quality information, comprising:
sending, by a terminal device, a first data packet to a network device, wherein the first data packet comprises first indication information and M pieces of first channel quality information corresponding to N sub-channels, the first indication information indicates that the channel quality information in the first data packet is originally measured channel quality information, the first channel quality information is measured by the terminal device in a first time unit, the N sub-channels are communication channels between the terminal device and the network device, N is an integer greater than 1, and M is a positive integer less than or equal to N; and
sending, by the terminal device, a second data packet to the network device, wherein the second data packet comprises second indication information and L pieces of third channel quality information corresponding to the N sub-channels, third channel quality information corresponding to a first sub-channel in the N sub-channels indicates a difference between second channel quality information corresponding to first sub-channel and the first channel quality information corresponding to the first sub-channel, the second channel quality information is measured by the terminal device in a second time unit, the second indication information indicates that the channel quality information in the second data packet is non-originally measured channel quality information, L is a positive integer less than or equal to N, and the second time unit is later than the first time unit.

2. The method according to claim 1, wherein
the first data packet further comprises third indication information, and the third indication information indicates a quantity of bits of an integer part and a quantity of bits of a fractional part corresponding to the M pieces of first channel quality information; and
the second data packet further comprises fourth indication information, and the fourth indication information indicates a quantity of bits of an integer part and a quantity of bits of a fractional part corresponding to the L pieces of third channel quality information.

3. The method according to claim 2, wherein
the third indication information further indicates a quantity of bits of a sign part corresponding to the M pieces of first channel quality information; and
the fourth indication information further indicates a quantity of bits of a sign part corresponding to the L pieces of third channel quality information.

4. The method according to claim 1, wherein
the third channel quality information corresponding to the first sub-channel is equal to the difference between the second channel quality information corresponding to the first sub-channel and the first channel quality information corresponding to the first sub-channel.

5. The method according to claim 1, wherein
the M pieces of first channel quality information are in one-to-one correspondence with the N sub-channels, and M is equal to N; or
each of the M pieces of first channel quality information corresponds to at least one second sub-channel in the N sub-channels, different second sub-channels in the at least one second sub-channel have same first channel quality information, and M is less than N.

6. The method according to claim 1, wherein
the L pieces of third channel quality information are in one-to-one correspondence with the N sub-channels, and L is equal to N; or
each of the L pieces of third channel quality information corresponds to at least one third sub-channel in the N sub-channels, different third sub-channels in the at least one third sub-channel have same third channel quality information, and L is less than N.

7. The method according to claim 1, wherein
the first data packet further comprises fifth indication information, and the fifth indication information indicates a sequence number of the first data packet; and
the second data packet further comprises sixth indication information, and the sixth indication information indicates a sequence number of the second data packet.

8. The method according to claim 1, wherein the method further comprises:
receiving, by the terminal device, first instruction information from the network device, wherein the first instruction information indicates the terminal device to send a data packet corresponding to the originally measured channel quality information.

9. The method according to claim 1, wherein sending, by the terminal device, the second data packet to the network device comprises:
if a total quantity of bits corresponding to the L pieces of third channel quality information is less than a total quantity of bits of second channel quality information corresponding to the N sub-channels, sending, by the terminal device, the second data packet to the network device.

10. The method according to claim 9, wherein the method further comprises:
if the total quantity of bits corresponding to the L pieces of third channel quality information is greater than or equal to the total quantity of bits of the second channel quality information corresponding to the N sub-channels, sending, by the terminal device, a third data packet to the network device, wherein the third data packet comprises seventh indication information and the second channel quality information corresponding to the N sub-channels, and the seventh indication information indicates that the channel quality information in the third data packet is originally measured channel quality information.

11. A method for feeding back channel quality information, comprising:
receiving, by a network device, a first data packet from a terminal device, wherein the first data packet comprises first indication information and M pieces of first channel quality information corresponding to N sub-channels, the first indication information indicates that the channel quality information in the first data packet is originally measured channel quality information, the first channel quality information is measured by the terminal device in a first time unit, the N sub-channels are communication channels between the terminal device and the network device, N is an integer greater than 1, and M is a positive integer less than or equal to N; and
receiving, by the network device, a second data packet from the terminal device, wherein the second data packet comprises second indication information and L pieces of third channel quality information corresponding to the N sub-channels, third channel quality information corresponding to a first sub-channel in the N sub-channels indicates a difference between second channel quality information corresponding to first sub-channel and the first channel quality information corresponding to the first sub-channel, the second channel quality information is measured by the terminal device in a second time unit, the second indication information indicates that the channel quality information in the second data packet is non-originally measured channel quality information, L is a positive integer less than or equal to N, and the second time unit is later than the first time unit.

12. The method according to claim 11, wherein
the first data packet further comprises third indication information, and the third indication information indicates a quantity of bits of an integer part and a quantity of bits of a fractional part corresponding to the M pieces of first channel quality information; and
the second data packet further comprises fourth indication information, and the fourth indication information indicates a quantity of bits of an integer part and a quantity of bits of a fractional part corresponding to the L pieces of third channel quality information.

13. The method according to claim 12, wherein
the third indication information further indicates a quantity of bits of a sign part corresponding to the M pieces of first channel quality information; and
the fourth indication information further indicates a quantity of bits of a sign part corresponding to the L pieces of third channel quality information.

14. The method according to claim 11, wherein
the third channel quality information corresponding to the first sub-channel is equal to the difference between the second channel quality information corresponding to the first sub-channel and the first channel quality information corresponding to the first sub-channel.

15. The method according to claim 11 wherein
the M pieces of first channel quality information are in one-to-one correspondence with the N sub-channels, and M is equal to N; or
each of the M pieces of first channel quality information corresponds to at least one second sub-channel in the N sub-channels, different second sub-channels in the at least one second sub-channel have same first channel quality information, and M is less than N.

16. The method according to claim 11, wherein
the L pieces of third channel quality information are in one-to-one correspondence with the N sub-channels, and L is equal to N; or
each of the L pieces of third channel quality information corresponds to at least one third sub-channel in the N sub-channels, different third sub-channels in the at least one third sub-channel have same third channel quality information, and L is less than N.

17. The method according to claim 11, wherein
the first data packet further comprises fifth indication information, and the fifth indication information indicates a sequence number of the first data packet; and
the second data packet further comprises sixth indication information, and the sixth indication information indicates a sequence number of the second data packet.

18. The method according to claim 11, wherein the method further comprises:
sending, by the network device, first instruction information to the terminal device, wherein the first instruction information indicates the terminal device to send a data packet corresponding to the originally measured channel quality information.

19. The method according to claim 11, wherein the method further comprises:
receiving, by the network device, a third data packet from the terminal device, wherein the third data packet comprises seventh indication information and second channel quality information corresponding to the N sub-channels, and the seventh indication information indicates that the channel quality information in the third data packet is originally measured channel quality information.

20. A communication apparatus, comprising:
a transceiver unit, configured to send a first data packet to a network device, wherein the first data packet comprises first indication information and M pieces of first channel quality information corresponding to N sub-channels, the first indication information indicates that the channel quality information in the first data packet is originally measured channel quality information, the first channel quality information is measured in a first time unit, the N sub-channels are communication channels between the apparatus and the network device, N is an integer greater than 1, and M is a positive integer less than or equal to N, wherein
the transceiver unit is further configured to send a second data packet to the network device, wherein the second data packet comprises second indication information and L pieces of third channel quality information corresponding to the N sub-channels, third channel quality information corresponding to a first sub-channel in the N sub-channels indicates a difference between second channel quality information corresponding to the first sub-channel and the first channel quality information corresponding to first sub-channel, the second channel quality information is measured in a second time unit, the second indication information indicates that the channel quality information in the second data packet is non-originally measured channel quality information, L is a positive integer less than or equal to N, and the second time unit is later than the first time unit.
